(19) United States
(12) Patent Application Publication
(10) Pub. No.: US 2026/0212490 A1
(43) Pub. Date: Jul. 23, 2026

(54) EVALUATION APPARATUS, EVALUATION METHOD, AND STORAGE MEDIUM

(71) Applicant: NEC Network and Sensor Systems, Ltd, Tokyo (JP)

(72) Inventors: Naoaki IISAKA, Tokyo (JP); Takashi NAKANO, Tokyo (JP)

(73) Assignee: NEC Network and Sensor Systems, Ltd., Tokyo (JP)

(21) Appl. No.: 19/441,129

(22) Filed: Jan. 6, 2026

(30) Foreign Application Priority Data
Jan. 20, 2025 (JP) 2025-007926

(51) Int. Cl. G06T 7/00; G06T 7/60; G06T 17/00

(52) U.S. Cl. CPC G06T 7/001; G06T 7/60; G06T 17/00

(57) ABSTRACT

A evaluation apparatus acquires pre-assembly image data obtained by performing imaging to include connection units detects the actual dimension of shapes of the connection units from the pre-assembly image data acquired, generates an ideal assembly model representing a positional relationship between two of the connection units having a connection relationship in a case where the target objects are virtually assembled such that a predetermined property of a formed object is optimized, based on the actual dimension, acquires post-assembly image data obtained by performing imaging to include a connection portion of an assembly obtained by actually assembling the target objects, generates an actual assembly model representing the positional relationship between the two of the connection units having the connection relationship in the assembly based on the post-assembly image data acquired and the actual dimension, and evaluates the actual assembly model based on the ideal assembly model.

This application is based upon and claims the benefit of priority from Japanese patent application No. 2025-007926, filed on Jan. 20, 2025, the disclosure of which is incorporated herein in its entirety by reference.

### TECHNICAL FIELD

The present disclosure relates to an evaluation apparatus, an evaluation method, and a program.

### BACKGROUND ART

JP 2016-012771 A discloses a waveguide tube connection structure that suppresses positional deviation and the like that occur when a plurality of dielectric substrates on which waveguide tubes are formed are connected.

### SUMMARY

However, there is a problem that manufacturing a target object such as a component having a special connection structure as disclosed in JP 2016-012771 A requires cost. If not all the target objects have a special connection structure as disclosed in JP 2016-012771 A, there is a problem that positional deviation and the like cannot be suppressed. Therefore, there is a problem that it is desired to suppress the occurrence of positional deviation or the like at the time of connection of the target objects without increasing the cost of providing a special connection structure in the plurality of target objects.

An object of the present disclosure is to provide an evaluation apparatus, an evaluation method, and a program that solve the above-described problems.

An evaluation apparatus according to one aspect of the present disclosure includes a pre-assembly image data acquisition means for acquiring pre-assembly image data generated by imaging by an imaging means to include a connection unit in a state where a target object is arranged such that an actual dimension of a shape of the connection unit of a plurality of the target object can be specified, an actual dimension detection means for detecting the actual dimension of the shape of the connection unit from the pre-assembly image data, an ideal assembly model generation means for generating an ideal assembly model representing a positional relationship between two of the connection unit having a connection relationship in a case where the target object is virtually assembled by connecting the target object at the connection unit such that a predetermined property of a formed object formed by connecting the target object at the connection unit is optimized, based on the actual dimension detected by the actual dimension detection means, a post-assembly image data acquisition means for acquiring post-assembly image data generated by imaging by an imaging means to include a connection portion of an assembly obtained by actually assembling the target object by connecting the target object at the connection unit, an actual assembly model generation means for generating an actual assembly model representing the positional relationship between the two of the connection unit having the connection relationship in the assembly based on the post-assembly image data and the actual dimension detected by the actual dimension detection means, and an evaluation means for evaluating the actual assembly model based on the ideal assembly model.

An evaluation method according to one aspect of the present disclosure includes acquiring pre-assembly image data generated by imaging by an imaging means to include a connection unit in a state where a target object is arranged such that an actual dimension of a shape of the connection unit of a plurality of the target object can be specified, detecting the actual dimension of the shape of the connection unit from the pre-assembly image data acquired, generating an ideal assembly model representing a positional relationship between two of the connection unit having a connection relationship in a case where the target object is virtually assembled by connecting the target object at the connection unit such that a predetermined property of a formed object formed by connecting the target object at the connection unit is optimized, based on the actual dimension detected, acquiring post-assembly image data generated by imaging by an imaging means to include a connection portion of an assembly obtained by actually assembling the target object by connecting the target object at the connection unit, generating an actual assembly model representing the positional relationship between the two of the connection unit having the connection relationship in the assembly based on the post-assembly image data acquired and the actual dimension detected, and evaluating the actual assembly model based on the ideal assembly model.

A program according to one aspect of the present disclosure is a program for causing a computer to function as a pre-assembly image data acquisition means for acquiring pre-assembly image data generated by imaging by an imaging means to include a connection unit in a state where a target object is arranged such that an actual dimension of a shape of the connection unit of a plurality of the target object can be specified, an actual dimension detection means for detecting the actual dimension of the shape of the connection unit from the pre-assembly image data, an ideal assembly model generation means for generating an ideal assembly model representing a positional relationship between two of the connection unit having a connection relationship in a case where the target object is virtually assembled by connecting the target object at the connection unit such that a predetermined property of a formed object formed by connecting the target object at the connection unit is optimized, based on the actual dimension detected by the actual dimension detection means, a post-assembly image data acquisition means for acquiring post-assembly image data generated by imaging by an imaging means to include a connection portion of an assembly obtained by actually assembling the target object by connecting the target object at the connection unit, an actual assembly model generation means for generating an actual assembly model representing the positional relationship between the two of the connection unit having the connection relationship in the assembly based on the post-assembly image data and the actual dimension detected by the actual dimension detection means, and an evaluation means for evaluating the actual assembly model based on the ideal assembly model.

According to the above aspect, it is possible to suppress the occurrence of positional deviation or the like at the time of connection of the target objects without increasing the cost of providing a special connection structure in the plurality of target objects.

### BRIEF DESCRIPTION OF THE DRAWINGS

FIG. 1A is a diagram illustrating a configuration example of a waveguide evaluation system according to the present disclosure;

FIG. 1B is a diagram illustrating an example of a component to be evaluated;

FIG. 2 is a diagram illustrating an example in which a component is arranged in a measurement jig according to the present disclosure, an example of pre-assembly image data obtained by imaging the arranged component, and an example of actual dimension obtained from the pre-assembly image data;

FIG. 3 is a flowchart illustrating an example of an imaging procedure by an imaging apparatus according to the present disclosure;

FIG. 4 is a diagram illustrating an example of an assembly according to the present disclosure, an example of post-assembly image data obtained by imaging the assembly, and an example of an actual assembly model generated from the post-assembly image data;

FIG. 5 is a flowchart illustrating an example of a flow of processing by the waveguide evaluation apparatus according to the present disclosure;

FIG. 6 is a diagram illustrating processing of generating an ideal assembly model according to the present disclosure;

FIG. 7 is a diagram illustrating processing of evaluating an actual assembly model based on the ideal assembly model according to the present disclosure;

FIG. 8 is a block diagram illustrating an example of an apparatus including a microwave tube, a drive circuit of the microwave tube, and a waveguide according to the present disclosure;

FIG. 9 is a block diagram illustrating a configuration example of a coaxial waveguide tube connection unit according to the present disclosure;

FIG. 10 is a block diagram illustrating a hardware configuration of a waveguide evaluation apparatus according to the present disclosure;

FIG. 11 is a block diagram illustrating an example of a configuration of an evaluation apparatus according to the present disclosure; and

FIG. 12 is a flowchart illustrating an example of a flow of processing by the evaluation apparatus according to the present disclosure.

### EXAMPLE EMBODIMENT

Hereinafter, each example embodiment will be described with reference to the drawings. In all the drawings, the same or related components are denoted by the same reference signs, and the common description will be omitted.

### First Example Embodiment

### (Configuration of Waveguide Evaluation System and Components to Be Evaluated)

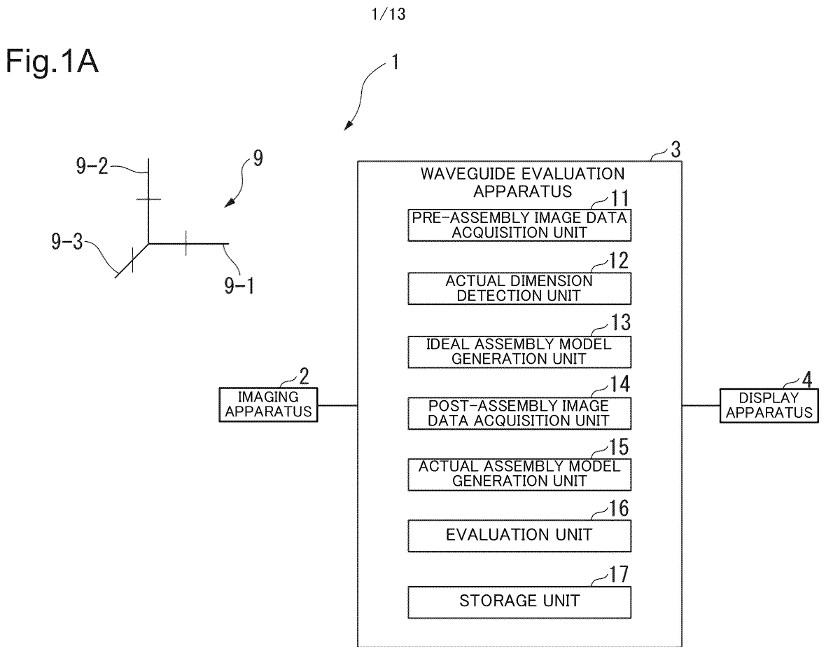

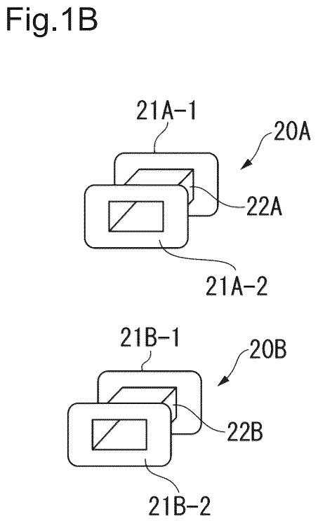

FIG. 1A is a diagram illustrating a waveguide evaluation system 1. FIG. 1B is a diagram illustrating components 20A and 20B to be evaluated by the waveguide evaluation system 1. The waveguide evaluation system 1 includes an imaging apparatus 2, a waveguide evaluation apparatus 3, a display apparatus 4, and a measurement jig 9. The imaging apparatus 2 is, for example, a camera, and may be a camera built in a digital camera or a smartphone. When the imaging apparatus 2 images a subject in response to an operation of a user who uses the waveguide evaluation system 1, the imaging apparatus 2 records image data obtained by the imaging in an internal storage area. The display apparatus 4 is, for example, a liquid crystal display or the like, and displays an image or the like represented by data supplied from the outside on a screen.

The measurement jig 9 illustrated in FIG. 1 is, for example, a jig in which three elongated rods 9-1, 9-2, and 9-3, each having actual-dimension scales provided thereon like a ruler and having a shape of a right circular cylinder or a rectangular prism, are connected and fixed at one ends thereof such that an angle formed by central axes of any two of the three rods is a right angle, and a central axis of the remaining one of the three rods perpendicularly intersects a plane formed by the two central axes. In other words, the measurement jig 9 is a jig in which the central axes of the three rods 9-1, 9-2, and 9-3 can be regarded as the X axis, the Y axis, and the Z axis in the three-dimensional spatial coordinate system.

For example, a rectangular parallelepiped hollow region serving as a waveguide tube is formed inside each of the components 20A and 20B illustrated in FIG. 1B. When each of the components 20A and 20B is connected such that each waveguide tube is continuous, a longer waveguide is formed by the continuous waveguide tube. Flanges serving as connection units with the other components 20B and 20A are provided at both ends of each of the components 20A and 20B. The surface of the connection unit (hereinafter, referred to as a connection surface) is processed into a plane so as not to generate a gap through which an electromagnetic wave or the like leaks from the waveguide when the connection unit is connected to the connection unit of the other components 20B and 20A. Hereinafter, the connection units at both ends of the component 20A are referred to as connection units 21A-1 and 21A-2, and the main body portion connecting the connection units 21A-1 and 21A-2 is referred to as a main body portion 22A. Similarly, connection units at both ends of the component 20B are referred to as connection units 21B-1 and 21B-2, and a main body portion connecting the connection units 21B-1 and 21B-2 is referred to as a main body portion 22B.

The waveguide evaluation apparatus 3 includes a pre-assembly image data acquisition unit 11, an actual dimension detection unit 12, an ideal assembly model generation unit 13, a post-assembly image data acquisition unit 14, an actual assembly model generation unit 15, an evaluation unit 16, and a storage unit 17. The waveguide evaluation apparatus 3 is connected to the imaging apparatus 2 and the display apparatus 4 via a wired or wireless line.

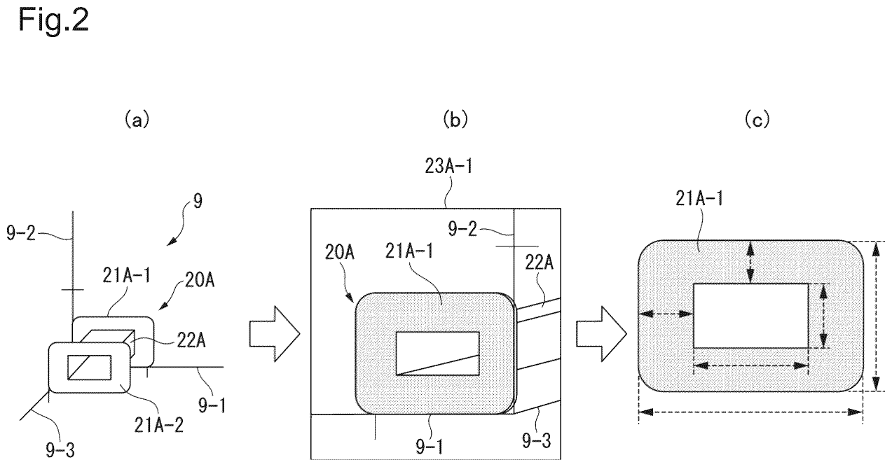

The pre-assembly image data acquisition unit 11 acquires pre-assembly image data generated by capturing an image of each of the components 20A and 20B by the imaging apparatus 2 in a state where the components are arranged so that the actual dimensions of the shapes of the connection units 21A-1, 21A-2, 21B-1, and 21B-2 can be specified. Here, arranging the connection units 21A-1, 21A-2, 21B-1, and 21B-2 so that the actual dimensions of the shapes can be specified means, for example, arranging the connection units as follows. In the case of specifying the actual dimension of the connection unit 21A-1 of the component 20A, for example, as illustrated in FIG. 2A, the connection surface of the connection unit 21A-1 and the plane formed by the central axes of the two rods 9-1 and 9-2 of the measurement jig 9 are arranged to be in parallel contact with each other, and the outer periphery of the connection unit 21A-1 is arranged to be in contact with the rods 9-1 and 9-2 as much as possible.

For example, it is assumed that the shape of the component 20A is the shape illustrated in FIG. 2A. That is, the shape of the connection units 21A-1 and 21A-2 is a plate-like shape in which the connecting surfaces of the connection units 21A-1 and 21A-2 have the same dimension and the same rectangular shape with rounded corners, and holes having the same dimension are formed at the same position. The shape of the main body portion 22A is a rectangular parallelepiped shape, is a rectangular parallelepiped hollow region having the same central axis as the central axis of the rectangular parallelepiped shape, and has a shape having a hollow region in which the shape of a cross section perpendicular to the central axis of the hollow region matches the shape of the hole of the connection units 21A-1 and 21A-2. The main body portion 22A couples each of the connection units 21A-1 and 21A-2 such that opening surfaces at both ends of the hollow region inside match the region of the hole of each of the connection units 21A-1 and 21A-2 and are perpendicular to the connection surface of each of the connection units 21A-1 and 21A-2. Therefore, the connection surfaces of the connection units 21A-1 and 21A-2 have a parallel positional relationship.

In this case, the connection surface of the connection unit 21A-1 and the connection surface of the connection unit 21A-2 are set as a top surface and a bottom surface, and the smallest rectangular parallelepiped that includes the component 20A can be assumed. If the component 20A is arranged such that the three sides of the assumed rectangular parallelepiped are along each of the rods 9-1, 9-2, and 9-3, the connection surface of the connection unit 21A-1 and the plane formed by the central axes of the two rods 9-1 and 9-2 of the measurement jig 9 are in parallel contact with each other, and the outer periphery of the connection unit 21A-1 can be arranged so as to be in contact with the rods 9-1 and 9-2 as much as possible.

The actual dimension detection unit 12 detects the actual dimensions of the shapes of the connection units 21A-1, 21A-2, 21B-1, and 21B-2 from the pre-assembly image data relevant to the connection units 21A-1, 21A-2, 21B-1, and 21B-2.

It is assumed that the component 20A and the component 20B are connected and assembled such that a predetermined property of a waveguide formed by connecting the component 20A and the component 20B is optimized, in other words, an ideal waveguide is obtained. The ideal assembly model generation unit 13 generates an ideal assembly model representing a positional relationship between the two connection units 21A-1, 21A-2, 21B-1, and 21B-2 having a connection relationship at the time of assembly in the assumption, based on the actual dimension detected by the actual dimension detection unit 12. Here, the predetermined property of the formed waveguide is, for example, a transmission loss of the waveguide, but may be a property other than the transmission loss, for example, impedance matching.

The post-assembly image data acquisition unit 14 acquires post-assembly image data generated by imaging by the imaging apparatus 2 so as to include a connection portion of an assembly actually assembled by connecting the component 20A and the component 20B. The actual assembly model generation unit 15 generates an actual assembly model representing a positional relationship between the two connection units 21A-1, 21A-2, 21B-1, and 21B-2 having a connection relationship in the assembly based on the post-assembly image data and the actual dimension detected by the actual dimension detection unit 12. The evaluation unit 16 evaluates the actual assembly model based on the actual assembly model and the ideal assembly model relevant to the actual assembly model, and outputs an evaluation result to the display apparatus 4. The storage unit 17 stores pre-assembly image data acquired by the pre-assembly image data acquisition unit 11, post-assembly image data acquired by the post-assembly image data acquisition unit 14, actual dimension data detected by the actual dimension detection unit 12, data indicating an ideal assembly model generated by the ideal assembly model generation unit 13, and data indicating an actual assembly model generated by the actual assembly model generation unit 15.

### (Imaging Procedure by Imaging Apparatus)

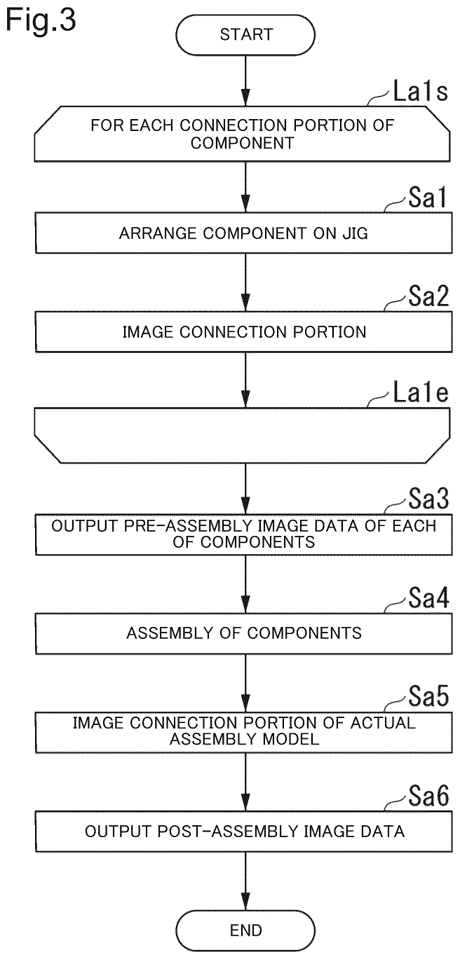

FIG. 3 is a flowchart illustrating a procedure in which the user images the components 20A and 20B using the imaging apparatus 2. For example, the user first disposes the component 20A on the measurement jig 9 as illustrated in FIG. 2A in order to image the connection unit 21A-1 of the component 20A (Sa1). The user performs imaging by the imaging apparatus 2 so as to include the scales of the rods 9-1 and 9-2 of the measurement jig 9 and the connection unit 21A-1. By this imaging, the imaging apparatus 2 generates pre-assembly image data 23A-1 relevant to the connection unit 21A-1 illustrated in FIG. 2B, and records the generated pre-assembly image data 23A-1 in an internal storage area (Sa2). A procedure similar to Sa1 and Sa2 for the connection unit 21A-1 is repeated for each of the connection unit 21A-2 of the component 20A and the connection units 21B-1 and 21B-2 of the component 20B (loops La1s to La1e).

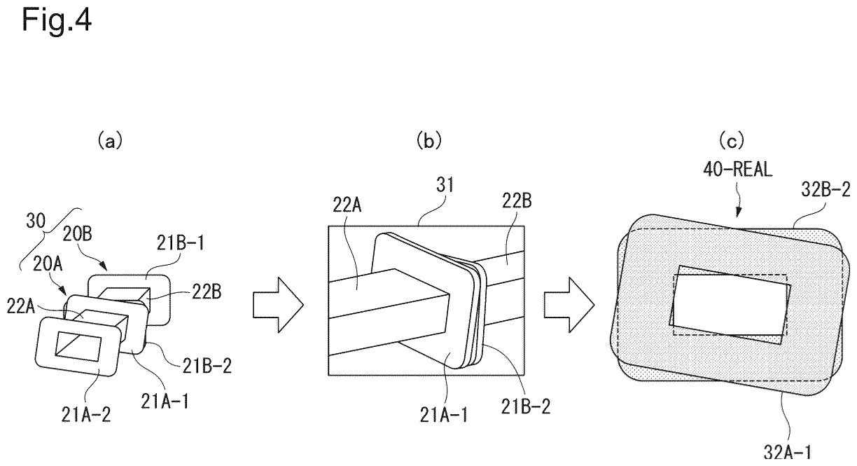

The user connects the imaging apparatus 2 to the waveguide evaluation apparatus 3. The user operates the imaging apparatus 2 to output the pre-assembly image data 23A-1, 23A-2, 23B-1, and 23B-2 relevant to the connection units 21A-1, 21A-2, 21B-1, and 21B-2 stored in the storage area inside the imaging apparatus 2 to the waveguide evaluation apparatus 3 (Sa3). For example, as illustrated in FIG. 4A, the user actually connects the connection unit 21A-1 of the component 20A and the connection unit 21B-2 of the component 20B, and assembles the component 20A and the component 20B to construct the assembly 30 (Sa4). The user removes the imaging apparatus 2 from the waveguide evaluation apparatus 3, and performs imaging by the imaging apparatus 2 such that the entire connection portion of the assembly 30 is included. By this imaging, the imaging apparatus 2 generates, for example, the post-assembly image data 31 relevant to the connection portion of the assembly 30 illustrated in FIG. 4B, and records the generated post-assembly image data 31 in an internal storage area (Sa5).

The user again connects the imaging apparatus 2 to the waveguide evaluation apparatus 3. The user operates the imaging apparatus 2 to output the post-assembly image data 31 stored in the storage area inside the imaging apparatus 2 to the waveguide evaluation apparatus 3 (Sa6). As a result, the procedure of imaging the components 20A and 20B using the imaging apparatus 2 ends.

### (Evaluation Procedure by Waveguide Evaluation Apparatus)

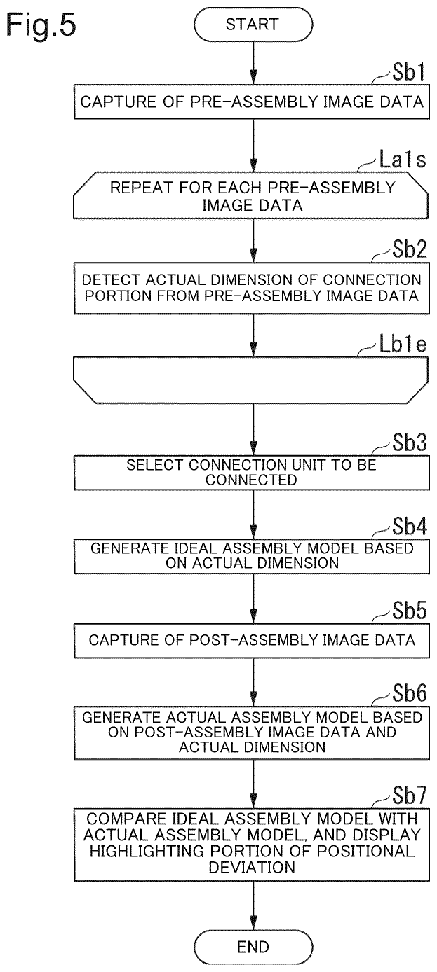

FIG. 5 is a flowchart illustrating a flow of processing by the waveguide evaluation apparatus 3. The pre-assembly image data acquisition unit 11 captures the pre-assembly image data 23A-1, 23A-2, 23B-1, and 23B-2 output from the imaging apparatus 2 in the procedure of Sa3 of FIG. 3. The pre-assembly image data acquisition unit 11 records the captured pre-assembly image data 23A-1, 23A-2, 23B-1, and 23B-2 in the storage unit 17. At the time of performing the recording, for example, the pre-assembly image data acquisition unit 11 generates different connection unit identification information for each of the pre-assembly image data 23A-1, 23A-2, 23B-1, and 23B-2, and records each of the generated connection unit identification information in association with each of the pre-assembly image data 23A-1, 23A-2, 23B-1, and 23B-2 relevant thereto. Here, the connection unit identification information is identification information that makes it possible to specify which one of the connection units 21A-1, 21A-2, 21B-2, and 21B-2 is relevant to each of the pre-assembly image data 23A-1, 23A-2, 23B-1, and 23B-2, and which one of the components 20A and 20B is relevant to each of the image data. Upon completion of the processing of recording the pre-assembly image data 23A-1, 23A-2, 23B-1, and 23B-2 in the storage unit 17, the pre-assembly image data acquisition unit 11 outputs an instruction signal to the actual dimension detection unit 12 (Sb1).

Upon receiving the instruction signal from the pre-assembly image data acquisition unit 11, the actual dimension detection unit 12 detects the actual dimensions of the connection units 21A-1, 21A-2, 21B-1, and 21B-2 from each of the pre-assembly image data 23A-1, 23A-2, 23B-1, and 23B-2 stored in the storage unit 17. For example, in the case of the connection unit 21A-1, as illustrated in FIG. 2B, the image indicated by the pre-assembly image data 23A-1 relevant to the connection unit 21A-1 includes the image of the connection unit 21A-1 and the image of the measurement jig 9. Therefore, for example, the actual dimension detection unit 12 performs image processing on the pre-assembly image data 23A-1, and detects the actual dimension of the connection unit 21A-1 from the scales of the rods 9-1 and 9-2 of the measurement jig 9. For example, as illustrated in FIG. 2C, the actual dimension detection unit 12 detects the lengths at 6 points indicated by the line segments of the dashed double-ended arrows as the actual dimension of the connection unit 21A-1. The portions detected as the actual dimensions by the actual dimension detection unit 12 are determined in advance according to the shapes of the connection units 21A-1, 21A-2, 21B-1, and 21B-2, and the number of the portions increases and decreases according to the shapes of the connection units 21A-1, 21A-2, 21B-1, and 21B-2.

The actual dimension detection unit 12 records the connection unit identification information associated with the pre-assembly image data 23A-1 in the storage unit 17 in association with the actual dimension data of the connection unit 21A-1 (Sb2). The actual dimension detection unit 12 performs processing similar to the processing performed on the pre-assembly image data 23A-1 on the pre-assembly image data 23A-2, 23B-1, and 23B-2 stored in the storage unit 17 (loops Lb1s to Lb1e). As a result, actual dimension data relevant to each of the connection units 21A-1, 21A-2, 21B-1, and 21B-2 is recorded in the storage unit 17.

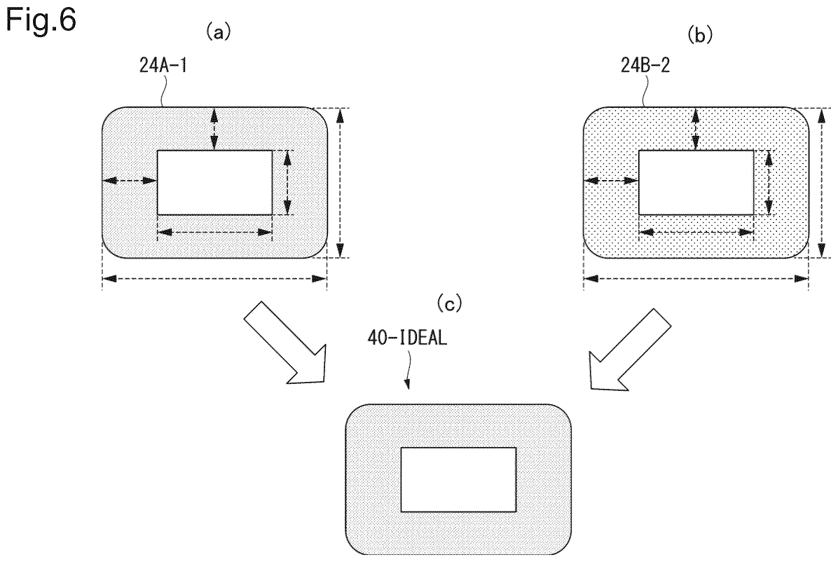

The user performs, on the ideal assembly model generation unit 13, an operation to provide the ideal assembly model generation unit 13 with connection unit identification information of each of the connection unit 21A-1 of the component 20A and the connection unit 21B-2 of the component 20B constituting the connection portion of the assembly 30 to be assembled in the procedure of Sa4 of FIG. 3 (Sb3). Upon receiving the operation, the ideal assembly model generation unit 13 reads the actual dimension data of the connection unit 21A-1 relevant to the connection unit identification information of the connection unit 21A-1 and the actual dimension data of the connection unit 21B-2 relevant to the connection unit identification information of the connection unit 21B-2 from the storage unit 17. The ideal assembly model generation unit 13 generates the connection unit model 24A-1 of the connection unit 21A-1 illustrated in FIG. 6A based on the actual dimension data of the connection unit 21A-1. The ideal assembly model generation unit 13 generates the connection unit model 24B-2 of the connection unit 21B-2 illustrated in FIG. 6B based on the actual dimension data of the connection unit 21B-2.

By connecting the connection unit 21A-1 and the connection unit 21B-2, the ideal assembly model generation unit 13 virtually connects the connection unit 21A-1 and the connection unit 21B-2 such that the predetermined property of the waveguide formed by each of the components 20A and 20B is optimized. That is, the ideal assembly model generation unit 13 superimposes each of the connection unit models 24A-1 and 23B-2 such that the predetermined property of the waveguide formed by each of the components 20A and 20B is optimized. For example, it is assumed that the shape of the component 20B is the same as the shape of the component 20A. In this case, as illustrated in FIG. 6C, the ideal assembly model generation unit 13 can optimize predetermined properties of the waveguides to be formed by superimposing the hole regions of the connection unit models 24A-1 and 23B-2 so as to match each other. Here, since the shape of the component 20A and the shape of the component 20B are the same, the outer peripheries of the connection unit models 24A-1 and 23B-2 also match each other when the hole regions are superimposed so as to match each other.

In this manner, a model generated by the ideal assembly model generation unit 13 superimposing each of the connection unit models 24A-1 and 23B-2 is the ideal assembly model 40-IDEAL. The ideal assembly model generation unit 13 associates the connection unit identification information of the connection unit 21A-1 associated with the actual dimension data of the connection unit 21A-1 and the connection unit identification information of the connection unit 21B-2 associated with the actual dimension data of the connection unit 21B-2 with the data indicating the generated ideal assembly model 40-IDEAL, and records them in the storage unit 17 (Sb4).

The post-assembly image data acquisition unit 14 captures the post-assembly image data 31 output from the imaging apparatus 2 in the procedure of Sa6 of FIG. 3. The post-assembly image data acquisition unit 14 records the captured post-assembly image data 31 in the storage unit 17. At the time of performing the recording, the post-assembly image data acquisition unit 14 records the connection unit identification information of each of the connection units 21A-1 and 21B-2 given by the user's operation and the connection unit positional relationship information in the storage unit 17 in association with the post-assembly image data 31, for example. Here, the connection unit positional relationship information is, for example, information indicating a positional relationship between the connection units 21A-1 and 21B-2 in the post-assembly image data 31 such that the connection unit 21A-1 is illustrated on the left side and the connection unit 21B-2 is illustrated on the right side in the post-assembly image data 31 illustrated in FIG. 4B. Upon completion of the processing of recording the post-assembly image data 31 in the storage unit 17, the post-assembly image data acquisition unit 14 outputs an instruction signal including the connection unit identification information of each of the connection units 21A-1 and 21B-2 to the actual assembly model generation unit 15 (Sb5).

Upon receiving the instruction signal from the post-assembly image data acquisition unit 14, the actual assembly model generation unit 15 reads the post-assembly image data 31 associated with the connection unit identification information of both the connection units 21A-1 and 21B-2 included in the instruction signal and the connection unit positional relationship information associated with the post-assembly image data 31 from the storage unit 17. The actual assembly model generation unit 15 reads the actual dimension data of the connection unit 21A-1 relevant to the connection unit identification information of the connection unit 21A-1 and the actual dimension data of the connection unit 21B-2 relevant to the connection unit identification information of the connection unit 21B-2 from the storage unit 17.

The actual assembly model generation unit 15 generates the actual assembly model 40-REAL illustrated in FIG. 4C based on the post-assembly image data 31, the connection unit positional relationship information, and the actual dimension data of each of the connection units 21A-1 and 21B-2. For example, the actual assembly model generation unit 15 performs image processing on the post-assembly image data 31, removes the image of the background and the images of the main body portions 22A and 22B of the components 20A and 20B from the image indicated in the post-assembly image data 31, and extracts the image of the connection portion where the connection units 21A-1 and 21B-2 overlap. The actual assembly model generation unit 15 specifies a portion of the image of the connection unit 21A-1 and a portion of the image of the connection unit 21B-2 in the image of the connection portion where the connection units 21A-1 and 21B-2 overlap based on the connection unit positional relationship information. The actual assembly model generation unit 15 extracts the contour of the connection unit 21A-1 from the portion of the image of the connection unit 21A-1 and extracts the contour of the connection unit 21B-2 from the portion of the image of the connection unit 21B-2 while maintaining the positional relationship between the images of the connection units 21A-1 and 21B-2.

The actual assembly model generation unit 15 calculates the position of the viewpoint of the imaging apparatus 2 when the post-assembly image data 31 is obtained by imaging from the angle of view of the post-assembly image data 31. Based on the calculated position of the viewpoint of the imaging apparatus 2, the actual assembly model generation unit 15 performs conversion processing of converting the contour of each of the connection units 21A-1 and 21B-2 into a contour observed from the viewpoint in the ideal assembly model 40-IDEAL, that is, a contour observed in a case where the viewpoint is placed in front of the connection surface of each of the connection units 21A-1 and 21B-2.

The actual assembly model generation unit 15 performs processing of enlarging or reducing the contour of each of the connection units 21A-1 and 21B-2 obtained by the conversion processing such that the size of the contour matches the size in the actual dimension based on the relevant actual dimension data. The actual assembly model generation unit 15 performs processing of complementing the shape of the connection unit 21A-1 hidden by the main body portion 22A of the component 20A, the shape of the connection unit 21B-2 hidden by the connection unit 21A-1, and the shape of the hole of each of the connection units 21A-1 and 21B-2 not displayed in the post-assembly image data 31 based on the data indicating the contour of each of the connection units 21A-1 and 21B-2 after the enlargement or reduction processing and the relevant actual dimension data. As a result, the actual assembly model 40-REAL including the connection unit model 32A-1 representing the shape of the connection unit 21A-1 and the connection unit model 32B-2 representing the shape of the connection unit 21B-2 illustrated in FIG. 4C is obtained.

The actual assembly model generation unit 15 associates the connection unit identification information of both of the connection units 21A-1 and 21B-2 included in the instruction signal with the data indicating the generated actual assembly model 40-REAL, and records the data in the storage unit 17. Upon completion of the processing of recording the data indicating the actual assembly model 40-REAL in the storage unit 17, the actual assembly model generation unit 15 outputs an instruction signal including the connection unit identification information of each of the connection units 21A-1 and 21B-2 to the evaluation unit 16 (Sb6).

Upon receiving the instruction signal from the actual assembly model generation unit 15, the evaluation unit 16 reads, from the storage unit 17, the ideal assembly model 40-IDEAL and the actual assembly model 40-REAL associated with the connection unit identification information of both the connection units 21A-1 and 21B-2 included in the instruction signal. The evaluation unit 16 evaluates the actual assembly model 40-REAL based on the ideal assembly model 40-IDEAL.

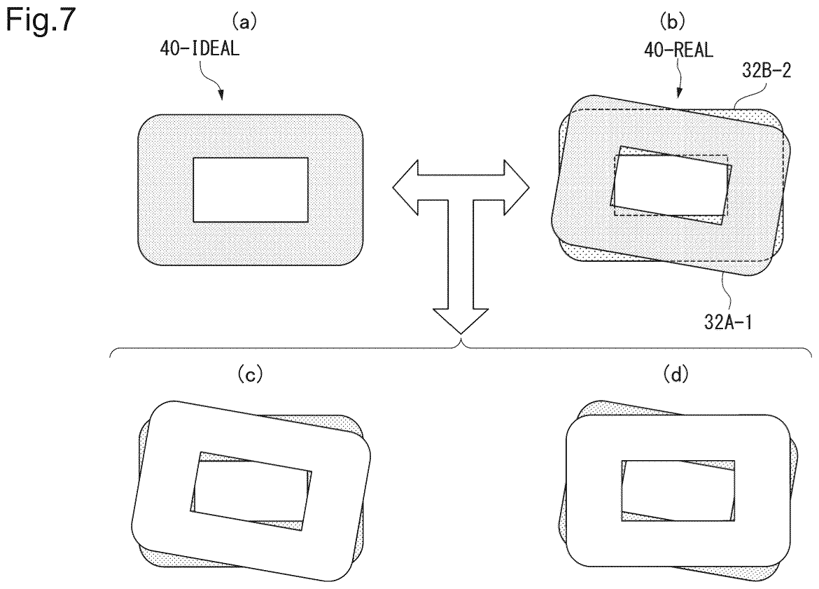

The evaluation unit 16 performs, for example, the following evaluation as the evaluation of the actual assembly model 40-REAL. The evaluation unit 16 superimposes the ideal assembly model 40-IDEAL illustrated in FIG. 7A on the actual assembly model 40-REAL illustrated in FIG. 7B. The ideal assembly model 40-IDEAL and the actual assembly model 40-REAL are expressed in actual dimensions according to the actual dimension data of each of the connection units 21A-1 and 21B-2. In the ideal assembly model 40-IDEAL, since the components 20A and 20B are assembled so that the predetermined property of the formed waveguide is optimized, the regions of the holes of the connection units 21A-1 and 21B-2 match. The data of the actual assembly model 40-REAL includes data indicating the shape of each hole of the connection units 21A-1 and 21B-2. Therefore, the evaluation unit 16 superimposes the ideal assembly model 40-IDEAL and the actual assembly model 40-REAL such that the region of the hole of the ideal assembly model 40-IDEAL matches the region of any one of the hole of the connection unit 21A-1 and the hole of the connection unit 21B-2 included in the actual assembly model 40-REAL.

FIG. 7C illustrates an example in which the region of the hole of the ideal assembly model 40-IDEAL is matched with the region of the hole of the connection unit model 32A-1 relevant to the connection unit 21A-1 included in the actual assembly model 40-REAL. FIG. 7D illustrates an example in which the region of the hole of the ideal assembly model 40-IDEAL is matched with the region of the hole of the connection unit model 32B-2 relevant to the connection unit 21B-2 included in the actual assembly model 40-REAL.

After the ideal assembly model 40-IDEAL and the actual assembly model 40-REAL are superimposed on each other, as illustrated in FIGS. 7C and 7D, the evaluation unit 16 generates an image in which a region of the ideal assembly model 40-IDEAL is represented in white and a region of the actual assembly model 40-REAL that does not match the ideal assembly model 40-IDEAL is highlighted and displayed by hatching. The evaluation unit 16 outputs the generated image to the display apparatus 4, displays the images illustrated in FIGS. 7C and 7D on the screen of the display apparatus 4 (Sb7), and ends the processing. The image of FIG. 7C can indicate the positional deviation of the connection unit 21B-2 in the actual assembly model 40-REAL to the user, and the image of FIG. 7D can indicate the positional deviation of the connection unit 21A-1 in the actual assembly model 40-REAL to the user.

As described above, in addition to displaying the positional deviation, that is, the mismatch portion, the evaluation unit 16 may detect the positional deviation amount of each mismatch portion, output a warning to the display apparatus 4 according to the magnitude of the detected positional deviation amount, or output the determination result of the quality determination of each mismatch portion according to the positional deviation amount of each mismatch portion to the display apparatus 4.

In the processing illustrated in FIG. 5, in the processing of Sb3, the user performs an operation of providing the ideal assembly model generation unit 13 with connection unit identification information of each of the connection unit 21A-1 of the component 20A and the connection unit 21B-2 of the component 20B constituting the connection portion in the assembly 30 to be assembled in the procedure of Sa4 of FIG. 3. On the other hand, when the processing of Sb3 is removed from the processing of FIG. 5, and the actual dimension detection unit 12 completes the processing of the loops Lb1s to Lb1e, an instruction signal is output to the ideal assembly model generation unit 13. Upon receiving the instruction signal from the actual dimension detection unit 12, the ideal assembly model generation unit 13 may perform processing of generating an ideal assembly model for all connectable patterns of the connection unit 21A-1 and the connection unit 21B-1, the connection unit 21A-1 and the connection unit 21B-2, the connection unit 21A-2 and the connection unit 21B-1, and the connection unit 21A-2 and the connection unit 21B-2, and recording the ideal assembly model in the storage unit 17.

In the procedure of Sa1 and Sa2 of FIG. 3, all the connection units 21A-1, 21A-2, 21B-1, and 21B-2 of the components 20A and 20B are imaged by the imaging apparatus 2 to generate pre-assembly image data 23A-1, 23A-2, 23B-1, and 23B-2. On the other hand, in the assembly of the components 20A and 20B performed in the procedure of Sa4 of FIG. 3, what is actually connected is any one pattern of the connection unit 21A-1 and the connection unit 21B-1, the connection unit 21A-1 and the connection unit 21B-2, the connection unit 21A-2 and the connection unit 21B-1, and the connection unit 21A-2 and the connection unit 21B-2. Therefore, if it is known in advance that the connecting pattern in the procedure of Sa4 is, for example, the pattern of the connection unit 21A-1 and the connection unit 21B-2, the target of the procedure of Sa1 and Sa2 may be limited to two of the connection unit 21A-1 and the connection unit 21B-2.

The measurement jig 9 illustrated in FIG. 1A is an example, and any means may be used as long as the shapes of the connection units 21A-1, 21A-2, 21B-1, and 21B-2 of the components 20A and 20B can be specified by image processing.

### (Operation and Effect)

In the waveguide evaluation apparatus 3, the pre-assembly image data acquisition unit 11 acquires the pre-assembly image data 23A-1 and 23B-2 generated by imaging by the imaging apparatus 2 so as to include the connection units 21A-1 and 21B-2 in a state where the components 20A and 20B are arranged so that the actual dimensions of the shapes of the connection units 21A-1 and 21B-2 of the components 20A and 20B can be specified. The actual dimension detection unit 12 detects the actual dimensions of the shapes of the connection units 21A-1 and 21B-2 from the pre-assembly image data 23A-1 and 23B-2. The ideal assembly model generation unit 13 generates an ideal assembly model 40-IDEAL representing a positional relationship between the two connection units 21A-1 and 21B-2 having a connection relationship in a case where the components 20A and 20B are assembled such that predetermined properties of the formed waveguide are optimized, based on the actual dimension detected by the actual dimension detection unit 12. The post-assembly image data acquisition unit 14 acquires post-assembly image data 31 generated by imaging by the imaging apparatus 2 so as to include the connection portion of the assembly 30 obtained by actually assembling the components 20A and 20B. Based on the post-assembly image data 31 and the actual dimension detected by the actual dimension detection unit 12, the actual assembly model generation unit 15 generates an actual assembly model 40-REAL representing the positional relationship between the two connection units 21A-1 and 21B-2 having the connection relationship in the assembly 30. The evaluation unit 16 evaluates the actual assembly model 40-REAL based on the ideal assembly model 40-IDEAL.

By referring to the evaluation result by the evaluation unit 16, the positional deviation or the like in the assembly 30 is grasped and the connection state of the assembly 30 is adjusted, whereby the positional deviation or the like of the assembly 30 can be suppressed. Therefore, by using the waveguide evaluation apparatus 3, it is possible to suppress deterioration of the performance of the waveguide due to positional deviation or the like at the time of component connection without increasing the cost such as providing a special connection structure in the plurality of components 20A and 20B that form the waveguide by connecting the components.

As a method of determining the presence or absence of a positional deviation of a general waveguide component, that is, a matching state in a case where a component forming a waveguide does not have a special connection structure as disclosed in JP 2016-012771 A, there is a following method. For example, there is a method of determining the presence or absence of positional deviation by visually and manually touching the outer surface of the connection portion. There is a method of determining the presence or absence of positional deviation based on an image captured with X-rays. Regarding the determination of the presence or absence of unnecessary radiation from the waveguide, there is a method of performing determination by scanning a magnetic field probe and detecting a radiation source.

A method of determining the presence or absence of the positional deviation by visually and manually touching the outer surface of the connection portion is simple, but is a sensuous determination, the determination depends on individual differences of the person who makes the determination, and there is a problem that the positional deviation inside the waveguide cannot be determined. In an ultra-high frequency region represented by the terahertz band, the dimensions of the waveguide components are small, and thus, there is also a problem that it is difficult to perform accurate determination by a method relying on human sense.

The method of determining the presence or absence of the positional deviation based on the image captured by the X-ray has an advantage that the determination can be made without decomposing the matching state inside the waveguide component. Meanwhile, this method has problems that preparation for imaging takes time and effort, that an X-ray is used, and thus attention is required at the time of imaging, and that resolution of an image captured by the X-ray is lower than that of a normal photo. Since the method of determining the presence or absence of the positional deviation based on the image captured by the X-ray is finally performed by a human observing the image, there is also a problem that it is difficult to accurately determine the presence or absence of the positional deviation similarly to the method of determining the presence or absence of the positional deviation by visually and manually touching the outer surface of the connection portion. In the case of a method of evaluating unnecessary radiation with a magnetic field probe, there is a problem that it takes time because the entire area needs to be scanned.

On the other hand, in the method using the waveguide evaluation apparatus 3, what is required at the minimum in the determination of the matching state outside and inside the assembly 30 is the following data. For example, in a case where the components 20A and 20B used for forming the waveguides are actually connected to the connection units 21A-1 and 21B-2, three pieces of image data are the pre-assembly image data 23A-1 and 23B-2 obtained by arranging and imaging each of the connection units 21A-1 and 21B-2 on the measurement jig 9, and the post-assembly image data 31 obtained by imaging the connection portion of the assembly 30 obtained by assembling each of the components 20A and 20B. Therefore, the method using the waveguide evaluation apparatus 3 can be easily performed without taking time and effort and the matching state in the assembly 30 can also be determined without using X-rays as compared with a method of determining the presence or absence of positional deviation based on an image captured by X-rays or a method of scanning a magnetic field probe to detect a radiation source.

The ideal assembly model 40-IDEAL and the actual assembly model 40-REAL generated based on the pre-assembly image data 23A-1 and 23B-2 and the post-assembly image data 31 are represented by digitized data. Therefore, the evaluation performed by the evaluation unit 16 does not rely on human senses, and it is possible to perform more accurate determination of the matching state than a method of determining the presence or absence of the positional deviation by visually and manually touching the outer surface of the connection portion, that is, determination of the matching state by a human. As described above, in the ultra-high frequency region, the dimension of the waveguide component becomes small, and for example, in a case where the components 20A and 20B propagate an electromagnetic wave of 300 GHz, which is the upper limit frequency of the microwave, the size thereof is about 20 mm. On the other hand, even in a case where a smartphone camera is used as the imaging apparatus 2, the number of pixels is 10 million pixels or more. In the case of 10 million pixels, in a case where the number of pixels on one side is estimated to be 3000 pixels, when an object of 20 mm is imaged, the resolution is about 6 μm. Since the wavelength of the electromagnetic wave of 300 GHz is 1 mm, the pre-assembly image data and the post-assembly image data generated by the imaging apparatus 2 are image data having sufficient resolution.

### (Other Configuration Examples) (Part 1: Case Where Part of Connection Portion of Assembly 30 Is Shown in Post-Assembly Image Data)

In the example illustrated in FIG. 4B, the user performs imaging by the imaging apparatus 2 such that the entire connection portion of the assembly 30 is included. On the other hand, the user may generate the post-assembly image data 31 by performing imaging such that a part of the connection portion of the assembly 30 is included by the imaging apparatus 2. In the post-assembly image data 31 obtained in this case, a part of the connection unit 21A-1 is not shown, or a part of the connection unit 21B-2 is not shown. Therefore, in the processing of Sb6 in FIG. 5, the actual assembly model generation unit 15 can obtain the actual assembly model 40-REAL by performing processing of complementing a part not represented in the post-assembly image data 31 based on the data indicating the contour of each of the connection units 21A-1 and 21B-2 after performing the enlargement or reduction processing and the relevant actual dimension data.

### (Part 2: Generation of Actual Assembly Model Showing External Shape and Internal Shape of Component)

In the example illustrated in FIG. 2B, the image indicated by the pre-assembly image data 23A-1 represents the connection unit 21A-1 of the component 20A and a part of the main body portion 22A. As described above, the component 20A has a shape in which the connection surface of the connection unit 21A-1 and the connection surface of the connection unit 21A-2 are the top surface and the bottom surface, and the smallest rectangular parallelepiped including the component 20A can be assumed. Therefore, as illustrated in FIG. 2A, one of the sides of the component 20A from the top surface to the bottom surface is disposed along the rod 9-3 of the measurement jig 9. In the state of being arranged in this manner, imaging is performed such that the entire component 20A is included in the angle of view of the imaging apparatus 2. In this case, the pre-assembly image data 23A-1 relevant to the connection unit 21A-1 illustrated in FIG. 2B includes not only the image of the connection unit 21A-1 but also the image of the connection unit 21A-2. Therefore, the actual dimension detection unit 12 can detect the actual dimension of the length from the connection unit 21A-1 to the connection unit 21A-2, that is, the horizontal length of the component 20A by the scale of the rod 9-3 of the measurement jig 9 shown in the image of the pre-assembly image data 23A-1.

Also in the case of imaging the connection unit 21A-2, similarly to the case of imaging the connection unit 21A-1, imaging is performed such that the entire component 20A is included. From each of the pre-assembly image data 23A-1 and 23A-2 obtained by the imaging, it is possible to obtain actual data that can specify the external shape of each of the connection units 21A-1 and 21A-2 and the main body portion 22A and the internal shape that is the shape of the waveguide tube.

As for the component 20B, similarly to the component 20A, if actual data that can specify the external shape and the internal shape can be obtained, the actual assembly model generation unit 15 can generate the actual assembly model 40-REAL representing the external shape and the internal shape of each of the components 20A and 20B. In this case, the actual assembly model generation unit 15 converts data representing the actual assembly model 40-REAL representing the external shape and the internal shape of each of the components 20A and 20B into, for example, a format of three-dimensional model data that can be read by an external analysis means, and outputs the data to the external analysis means. Here, the format of the three-dimensional model data may be, for example, a drawing exchange format (DXF) or another format. In a case where the external analysis means is, for example, electromagnetic field analysis software or the like, simulation of impedance matching characteristics is performed based on the three-dimensional model data converted and output by the actual assembly model generation unit 15, and a deviation amount of impedance of the assembly 30 or the like can be detected.

An external analysis means returns a simulation result of impedance matching characteristics to the evaluation unit 16. In this way, the evaluation unit 16 can indicate the deviation amount of impedance for each mismatch portion, output a warning to the display apparatus 4 according to the deviation amount of impedance, and output the determination result of the quality determination for each mismatch portion according to the deviation amount of impedance for each mismatch portion to the display apparatus 4. The evaluation unit 16 can also output the quality determination of the entire waveguide formed in the assembly 30 to the display apparatus 4.

The evaluation unit 16 may include an external analysis means. In this case, since the waveguide evaluation apparatus 3 can obtain the deviation amount of impedance in addition to the positional deviation amount of connection, the waveguide evaluation apparatus 3 can also be used as an evaluation apparatus that evaluates the connection of the waveguide and evaluates the impedance.

### (Part 3: Waveguide Connected to Apparatus)

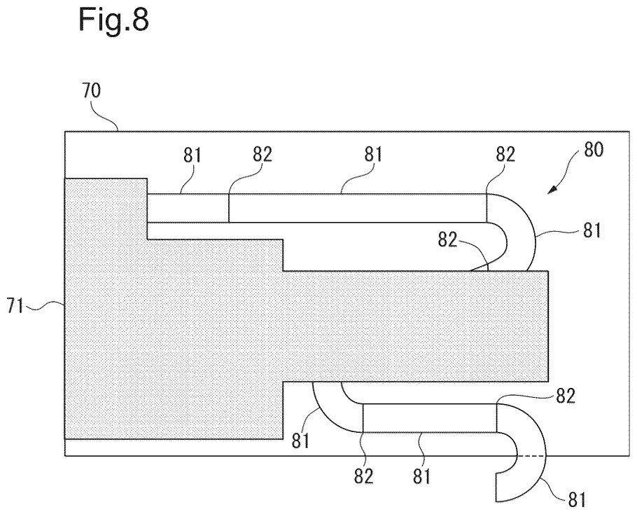

FIG. 8 is a block diagram illustrating an apparatus 70 including a microwave tube, a shield box 71 in which a drive circuit of the microwave tube is installed, and a waveguide assembly 80 in which a waveguide connected to the microwave tube in the shield box 71 is formed. As in the components 20A and 20B described above, the waveguide assembly 80 is formed by connecting a plurality of components 81 in which waveguides are formed, and thus there are a plurality of connection portions 82. In this case, one of the two adjacent components 81 in the waveguide assembly 80 is regarded as the component 20A and the other is regarded as the component 20B, and the imaging procedure illustrated in FIG. 3 is performed on each of the components 81 before the waveguide assembly 80 illustrated in FIG. 8 is assembled and each of the connection portions 82. As a result, the pre-assembly image data relevant to each of the connection units at both ends of the individual component 81 and the post-assembly image data relevant to each of the connection portions 82 are obtained. Each of the connection portions 82 can be evaluated by performing the processing illustrated in FIG. 5 on the pre-assembly image data and the post-assembly image data obtained in this manner. In the case of the apparatus 70, the presence or absence of unnecessary radiation from the plurality of connection portions 82 of the waveguide assembly 80 is a main problem. Therefore, the evaluation unit 16 can indicate to the user whether unnecessary radiation is generated according to the magnitude of the positional deviation amount by outputting the positional deviation amount of each of the connection portions 82 to the display apparatus 4.

The waveguide assembly 80 illustrated in FIG. 8 is formed by connecting the component 81 having a waveguide tube with a straight path and the component 81 having a waveguide tube with a curved path. With respect to the component 81 having the waveguide tube with the straight path, the actual assembly model generation unit 15 can specify the external shape and the internal shape by the method described in (Part 2: Generation of Actual Assembly Model Showing External Shape and Internal Shape of Component) above. On the other hand, with respect to the component 81 having the waveguide tube whose path is bent, it is difficult for the actual assembly model generation unit 15 to specify the external shape and the internal shape by the above-described method. In a case where it is desired to specify the external shape and the internal shape of the component 81 having the waveguide tube whose path is bent, for example, by giving computer aided design (CAD) data of the component 81 to the actual assembly model generation unit 15 as additional dimension data, the external shape and the internal shape can be specified.

### (Part 4: Identifying Means of Connection Unit in Image Indicated by Post-Assembly Image Data)

In the processing of Sb5 in FIG. 5, the post-assembly image data acquisition unit 14 acquires connection unit positional relationship information given by a user's operation and associates the connection unit positional relationship information with the post-assembly image data 31. With reference to the connection unit positional relationship information, the actual assembly model generation unit 15 specifies the portion of each image of the connection units 21A-1 and 21B-2 represented in the image indicated by the post-assembly image data 31 in the processing of Sb6.

On the other hand, in a case where the number of components 81 is large as in the waveguide assembly 80 of the apparatus 70 illustrated in FIG. 8, the number of pieces of post-assembly image data 31 is also large, and thus the number of times the user gives the connection unit positional relationship information is also large, which takes time and effort. Therefore, without providing the post-assembly image data acquisition unit 14 with the connection unit positional relationship information, which portion of the image indicated by the post-assembly image data relevant to each of the connection portions 82 is the connection unit of which component 81 may be specified as follows.

For example, in a case of acquiring the pre-assembly image data relevant to each of the connection units at both ends of one component 81 in the processing of Sb1 of FIG. 5, the pre-assembly image data acquisition unit 11 detects a feature that can uniquely specify the component 81 from a scratch or the like of the component 81 represented in the image indicated by the pre-assembly image data by image processing. When recording the pre-assembly image data in the storage unit 17, the pre-assembly image data acquisition unit 11 records feature data indicating the detected feature in association with the pre-assembly image data. The pre-assembly image data acquisition unit 11 may detect a plurality of features from one piece of pre-assembly image data. In this case, the pre-assembly image data is associated with a plurality of pieces of feature data. Since the connection surface of the connection unit becomes invisible when assembled, the pre-assembly image data acquisition unit 11 excludes the connection surface of the connection unit and detects the feature.

When acquiring the post-assembly image data in the processing of Sb5 in FIG. 5, the post-assembly image data acquisition unit 14 associates the connection unit identification information of each of the two connection units indicated in the image indicated by the post-assembly image data, which is the connection unit identification information given by the operation of the user, with the post-assembly image data 31 and records the connection unit identification information in the storage unit 17. The post-assembly image data acquisition unit 14 performs image processing on the recorded post-assembly image data, and detects a feature of each of the two components 81 represented in the image indicated by the post-assembly image data. The post-assembly image data acquisition unit 14 reads, from the storage unit 17, feature data associated with the pre-assembly image data relevant to each of the two connection unit identification information associated with the post-assembly image data subjected to the image processing.

The post-assembly image data acquisition unit 14 selects a feature matching the feature indicated by the read feature data from among the detected features. It is assumed that the post-assembly image data acquisition unit 14 selects one or more features matching the features indicated by the feature data for each of the two components 81.

The post-assembly image data acquisition unit 14 records a combination of the position of the selected feature in the image indicated by the post-assembly image data and the connection unit identification information relevant to the pre-assembly image data associated with the feature data indicating the feature matching the feature in the storage unit 17 in association with the post-assembly image data. Since two components 81 are represented in the image indicated by the post-assembly image data, at least one combination of the position relevant to each of the two components 81 and the connection unit identification information is associated with the post-assembly image data stored in the storage unit 17.

By performing these pieces of processing, even if the connection unit identification information of each of the two connected components 81 and the connection unit positional relationship information are not given from the user in the processing of Sb5, the post-assembly image data acquisition unit 14 can associate information specifying which portion of the image indicated by the acquired post-assembly image data is the connection unit of which component 81 with the post-assembly image data. Therefore, the actual assembly model generation unit 15 can generate the actual assembly model based on the post-assembly image data stored in the storage unit 17, and the combination of the position associated with the post-assembly image data and the connection unit identification information.

### (Part 5: Coaxial Waveguide Tube Connection Unit)

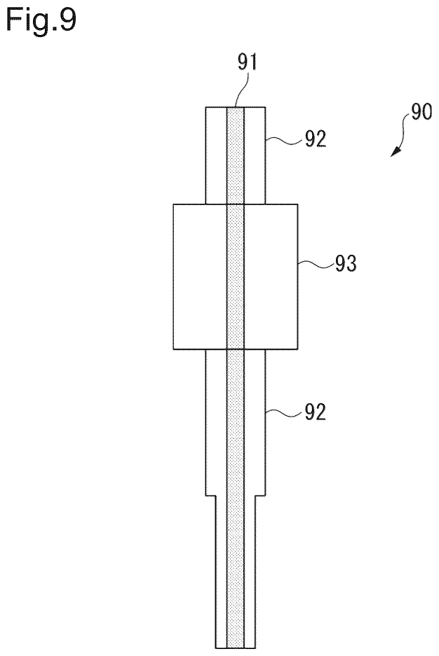

FIG. 9 is a block diagram illustrating a configuration of a coaxial waveguide tube connection unit 90 of the microwave tube. The coaxial waveguide tube connection unit 90 includes a coaxial inner conductor 91, a coaxial outer conductor 92, and a ceramic window 93. The coaxial waveguide tube connection unit 90 is connected to a microwave tube (not shown) in a portion below the ceramic window 93, and is connected to a waveguide tube (not shown) in a portion above the ceramic window 93. Since the microwave tube performs a vacuum operation, the microwave tube is sealed by the ceramic window 93 to separate the vacuum from the air.

Since the microwave tube is also a type of waveguide tube, the coaxial waveguide tube connection unit 90 is a component connected at both ends to two components each having a waveguide tube. Therefore, in a case where the waveguide is formed using the coaxial waveguide tube connection unit 90, there are three components including the coaxial waveguide tube connection unit 90. In this case, two components of the coaxial waveguide tube connection unit 90 and the microwave tube connected below the coaxial waveguide tube connection unit 90 can be regarded as the components 20A and 20B, and two components of the coaxial waveguide tube connection unit 90 and the waveguide tube connected above the coaxial waveguide tube connection unit 90 can be regarded as the components 20A and 20B.

The imaging procedure illustrated in FIG. 3 is performed on each of the components such as the coaxial waveguide tube connection unit 90, the microwave tube, and the waveguide tube, the connection portion between the coaxial waveguide tube connection unit 90 and the microwave tube, and the connection portion between the coaxial waveguide tube connection unit 90 and the waveguide tube. However, for the microwave tube and the waveguide tube, pre-assembly image data of the connection unit on the side connected to the coaxial waveguide tube connection unit 90 may be obtained, and thus, four pieces of pre-assembly image data relevant to each of the connection units at both ends of the coaxial waveguide tube connection unit 90, the connection unit at one end connected to the coaxial waveguide tube connection unit 90 of the microwave tube, and the connection unit at one end connected to the coaxial waveguide tube connection unit 90 of the waveguide tube are obtained. For the post-assembly image data, two pieces of post-assembly image data relevant to the connection portion between the coaxial waveguide tube connection unit 90 and the microwave tube and the connection portion between the coaxial waveguide tube connection unit 90 and the waveguide tube are obtained.

The coaxial waveguide tube connection unit 90 is used as a component of a device including components forming a large number of waveguides, such as a travelling wave tube (TWT), which is a type of microwave tube, and a high power amplifier (HPA) equipped with a travelling wave tube. In these devices, if there is a positional deviation in connection between components, high frequency characteristics are deteriorated due to impedance mismatch, and unnecessary radiation to the outside occurs. In particular, the high-frequency input/output unit of the travelling wave tube in which the coaxial waveguide tube connection unit 90 is used has a structure in which not only impedance conversion but also a microwave tube as a high-frequency circuit unit is maintained in a vacuum state by the ceramic window 93. Therefore, a positional deviation of the coaxial waveguide tube connection unit 90 with respect to the microwave tube, a positional deviation of the coaxial waveguide tube connection unit 90 with respect to the waveguide tube, and a positional deviation of each of the coaxial inner conductor 91 and the coaxial outer conductor 92 greatly affect the performance of the device. In this case, by performing the processing illustrated in FIG. 5 on the pre-assembly image data and the post-assembly image data obtained as described above using the waveguide evaluation apparatus 3, the positional deviation can be easily evaluated. Therefore, by applying the waveguide evaluation apparatus 3 in the manufacturing scene of the device, the yield of the device can be improved.

### (Part 6: Modeling Using Additional Dimension Data Supplied From Outside)

The shape of the connection unit of the coaxial waveguide tube connection unit 90 illustrated in FIG. 9 is not a shape in which a hole is formed in a plane like the connection units 21A-1, 21A-2, 21B-1, and 21B-2 of the components 20A and 20B or the connection unit of the component 81 illustrated in FIG. 9, but a complicated shape. Therefore, even if the measurement jig 9 is disposed and the imaging apparatus 2 captures the image, the actual dimension detection unit 12 may not be able to detect the actual dimension enough to specify the shape of the connection unit of the coaxial waveguide tube connection unit 90 from the pre-assembly image data which is a planar image. In this case, actual dimension data necessary for the ideal assembly model generation unit 13 to complete the ideal assembly model is not obtained.

Therefore, for example, CAD data of a design drawing of the coaxial waveguide tube connection unit 90 may be provided to the ideal assembly model generation unit 13 as additional dimension data. When an ideal assembly model is generated, there is a case where a linear portion can be drawn if there is a partial dimension. In such a case, it is only necessary to provide additional dimension data indicating a part of the linear portion. In a case where the ideal assembly model cannot be completed even if the CAD data is provided as the additional dimension data, the ideal assembly model generation unit 13 may further display an alarm indicating that there is a missing dimension on the display apparatus 4. This alarm may include, for example, a message for prompting the user to generate additional dimension data so as to obtain missing actual dimension data, or for causing the imaging apparatus 2 to image the coaxial waveguide tube connection unit 90 from another angle, or for causing the measurement jig 9 to be arranged and imaged. When additional imaging is performed by the imaging apparatus 2, pre-assembly image data is added, and therefore, by the actual dimension detection unit 12 performing a process of detecting the actual dimension with respect to the added pre-assembly image data, data of the actual dimension is added to the storage unit 17.

Even in a case where the actual assembly model generation unit 15 is caused to specify the external shape and the internal shape by the method described in (Part 2: Generation of Actual Assembly Model Showing External Shape and Internal Shape of Component) above for the coaxial waveguide tube connection unit 90, the microwave tube connected to the coaxial waveguide tube connection unit 90, and the waveguide tube connected to the coaxial waveguide tube connection unit 90, the above-described additional dimension data used in generation of the ideal assembly model and the actual dimension data added to the storage unit 17 may be used when the actual dimension data is missing.

### <Hardware Configuration>

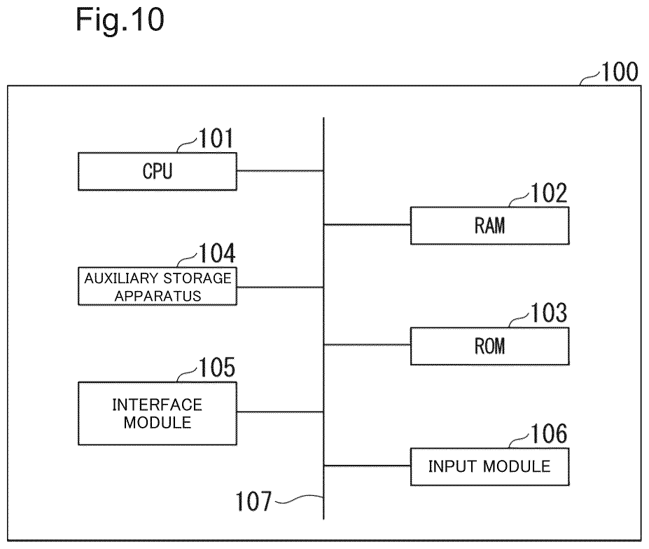

FIG. 10 is a diagram illustrating an example of a hardware configuration of the waveguide evaluation apparatus 3 illustrated in FIG. 1A according to the present disclosure. The waveguide evaluation apparatus 3 according to the present disclosure is, for example, a computer including a central processing unit (CPU) 101, a random access memory (RAM) 102, a read only memory (ROM) 103, an auxiliary storage apparatus 104, an interface module 105, and an input module 106. The CPU 101, the RAM 102, the ROM 103, the auxiliary storage apparatus 104, the interface module 105, and the input module 106 are mutually connected by a bus 107. The auxiliary storage apparatus 104 is, for example, a hard disk drive (HDD), a solid state drive (SSD), or the like. The interface module 105 is included in, for example, the pre-assembly image data acquisition unit 11 connected to the imaging apparatus 2, the post-assembly image data acquisition unit 14, the evaluation unit 16 connected to the display apparatus 4, and the like. The input module 106 is included in the ideal assembly model generation unit 13, the post-assembly image data acquisition unit 14, and the like that receive the user's operation.

When the CPU 101 executes an application program stored in advance in the ROM 103 or the auxiliary storage apparatus 104, the pre-assembly image data acquisition unit 11, the actual dimension detection unit 12, the ideal assembly model generation unit 13, the post-assembly image data acquisition unit 14, the actual assembly model generation unit 15, and the evaluation unit 16 are configured, and a storage area of the storage unit 17 is secured in the RAM 102 or the auxiliary storage apparatus 104.

### Second Example Embodiment

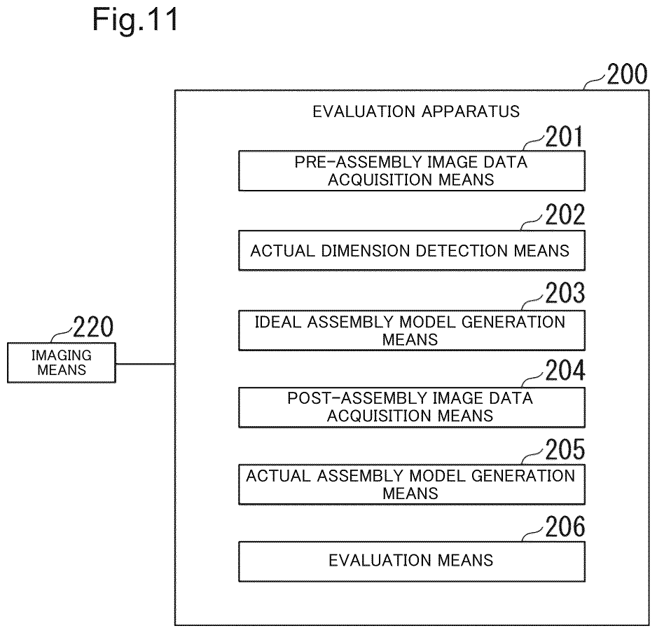

Hereinafter, one example embodiment according to the present disclosure will be described with reference to the drawings. As illustrated in FIG. 11, the evaluation apparatus 200 includes: a pre-assembly image data acquisition means 201 for acquiring pre-assembly image data generated by imaging by an imaging means 220 to include a connection unit in a state where a target object is arranged such that an actual dimension of a shape of the connection unit of a plurality of the target object can be specified; an actual dimension detection means 202 for detecting the actual dimension of the shape of the connection unit from the pre-assembly image data; an ideal assembly model generation means 203 for generating an ideal assembly model representing a positional relationship between two of the connection unit having a connection relationship in a case where the target object is virtually assembled by connecting the target object at the connection unit such that a predetermined property of a formed object formed by connecting the target object at the connection unit is optimized, based on the actual dimension detected by the actual dimension detection means 202; a post-assembly image data acquisition means 204 for acquiring post-assembly image data generated by imaging by an imaging means 220 to include a connection portion of an assembly obtained by actually assembling the target object by connecting the target object at the connection unit; an actual assembly model generation means 205 for generating an actual assembly model representing the positional relationship between the two of the connection unit having the connection relationship in the assembly based on the post-assembly image data and the actual dimension detected by the actual dimension detection means 202; and an evaluation means 206 for evaluating the actual assembly model based on the ideal assembly model.

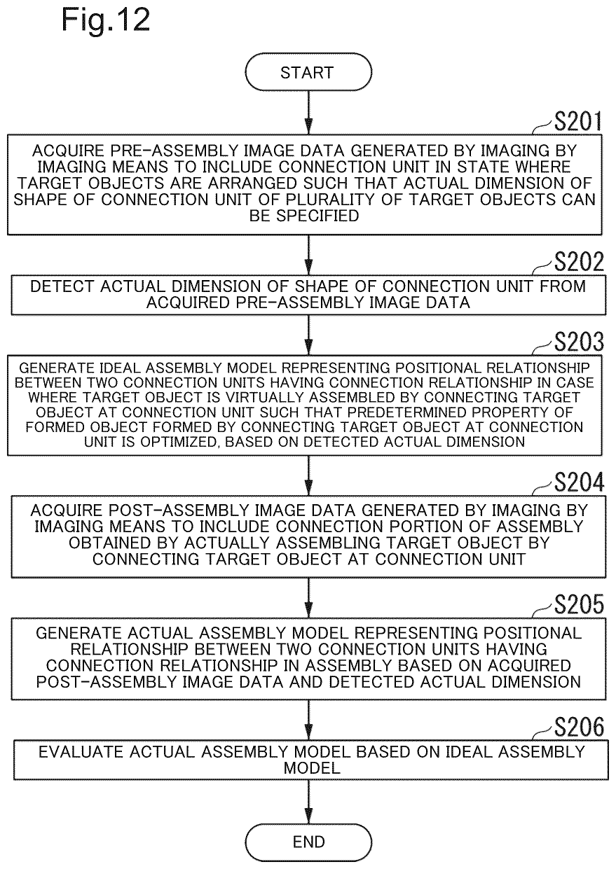

As illustrated in FIG. 12, the pre-assembly image data acquisition means 201 acquires pre-assembly image data generated by imaging by the imaging means 220 to include the connection unit in a state where the target object is arranged such that the actual dimension of the shape of the connection unit of the plurality of target objects can be specified (S201). The actual dimension detection means 202 detects the actual dimension of the shape of the connection unit from the pre-assembly image data acquired by the pre-assembly image data acquisition means 201 (S202). The ideal assembly model generation means 203 generates an ideal assembly model representing a positional relationship between two connection units having a connection relationship in a case where the target object is virtually assembled by connecting the target objects at the connection units such that a predetermined property of a formed object formed by connecting the target objects at the connection units is optimized, based on the actual dimension detected by the actual dimension detection means 202 (S203). The post-assembly image data acquisition means 204 acquires post-assembly image data generated by imaging by the imaging means 220 to include the connection portion of the assembly obtained by actually assembling the target object by connecting the target object at the connection unit (S204). The actual assembly model generation means 205 generates an actual assembly model representing a positional relationship between two connection units having a connection relationship in the assembly based on the post-assembly image data acquired by the post-assembly image data acquisition means 204 and the actual dimension detected by the actual dimension detection means 202 (S205). The evaluation means 206 evaluates the actual assembly model based on the ideal assembly model (S206).

That is, in another aspect, the waveguide evaluation apparatus 3 of the present disclosure may be the evaluation apparatus 200 that evaluates a formed object having a function similar to a waveguide other than a waveguide, and it is possible to suppress occurrence of positional deviation or the like at the time of connection of the target object without an increase in cost such as providing a special connection structure in the target object that forms a formed object having a function similar to a waveguide other than a waveguide.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

Some or all of the above example embodiments may be described as the following Supplementary Notes, but are not limited to the following.

(Supplementary Note 1) An evaluation apparatus (for example, the waveguide evaluation apparatus 3) including: a pre-assembly image data acquisition means (for example, the pre-assembly image data acquisition unit 11) for acquiring pre-assembly image data generated by imaging by an imaging means (for example, the imaging apparatus 2) to include a connection unit in a state where a target object (for example, the components 20A, 20B, and 81, and the coaxial waveguide tube connection unit 90) is arranged such that an actual dimension of a shape of the connection unit of a plurality of the target object can be specified; an actual dimension detection means (for example, the actual dimension detection unit 12) for detecting the actual dimension of the shape of the connection unit from the pre-assembly image data; an ideal assembly model generation means (for example, ideal assembly model generation unit 13) for generating an ideal assembly model representing a positional relationship between two of the connection unit having a connection relationship in a case where the target object is virtually assembled by connecting the target object at the connection unit such that a predetermined property of a formed object formed by connecting the target object at the connection unit is optimized, based on the actual dimension detected by the actual dimension detection means; a post-assembly image data acquisition means (for example, the post-assembly image data acquisition unit 14) for acquiring post-assembly image data generated by imaging by an imaging means (for example, the imaging apparatus 2) to include a connection portion of an assembly (for example, the assembly 30 and the waveguide assembly 80) obtained by actually assembling the target object by connecting the target object at the connection unit; an actual assembly model generation means (for example, the actual assembly model generation unit 15) for generating an actual assembly model representing the positional relationship between the two of the connection unit having the connection relationship in the assembly based on the post-assembly image data and the actual dimension detected by the actual dimension detection means; and an evaluation means (for example, the evaluation unit 16) for evaluating the actual assembly model based on the ideal assembly model.

(Supplementary Note 2) The evaluation apparatus according to (Supplementary Note 1), in which the formed object is a waveguide, and the plurality of the target object are components including a component having a waveguide tube and a component connected to the waveguide tube, or are components all having waveguide tubes.

(Supplementary Note 3) The evaluation apparatus according to (Supplementary Note 1) or (Supplementary Note 2), in which the evaluation means detects a deviation in the actual assembly model from the ideal assembly model as evaluation.

(Supplementary Note 4) The evaluation apparatus according to (Supplementary Note 3), in which the evaluation means outputs an evaluation result according to an amount of the deviation as the evaluation.

(Supplementary Note 5) The evaluation apparatus according to (Supplementary Note 3) or (Supplementary Note 4), in which the deviation is positional deviation or impedance deviation.

(Supplementary Note 6) The evaluation apparatus according to any one of (Supplementary Note 1) to (Supplementary Note 5), in which the ideal assembly model generation means generates the ideal assembly model based on the actual dimension detected by the actual dimension detection means and additional dimension data regarding a dimension of the target object supplied from outside.

(Supplementary Note 7) The waveguide evaluation apparatus according to any one of (Supplementary Note 1) to (Supplementary Note 6), in which the actual assembly model generation means generates the actual assembly model based on the post-assembly image data, the actual dimension detected by the actual dimension detection means, and the additional dimension data regarding the dimension of the target object supplied from outside.

(Supplementary Note 8) The waveguide evaluation apparatus according to any one of (Supplementary Note 1) to (Supplementary Note 7), in which the actual assembly model generation unit converts data indicating the actual assembly model to be generated into a format that can be taken in by an analysis means and outputs the data converted.

(Supplementary Note 9) The waveguide evaluation apparatus according to any one of (Supplementary Note 1) to (Supplementary Note 8), in which the actual assembly model generation means generates the actual assembly model by complementing a connection portion undisplayed in an image indicated by the post-assembly image data based on the actual dimension detected by the actual dimension detection means in a case where the post-assembly image data is generated by imaging to include a part of the connection portion of the assembly.

(Supplementary Note 10) An evaluation method including:
acquiring pre-assembly image data generated by imaging by an imaging means to include a connection unit in a state where a target object is arranged such that an actual dimension of a shape of the connection unit of a plurality of the target object can be specified; detecting the actual dimension of the shape of the connection unit from the pre-assembly image data acquired; generating an ideal assembly model representing a positional relationship between two of the connection unit having a connection relationship in a case where the target object is virtually assembled by connecting the target object at the connection unit such that a predetermined property of a formed object formed by connecting the target object at the connection unit is optimized, based on the actual dimension detected; acquiring post-assembly image data generated by imaging by an imaging means to include a connection portion of an assembly obtained by actually assembling the target object by connecting the target object at the connection unit; generating an actual assembly model representing the positional relationship between the two of the connection unit having the connection relationship in the assembly based on the post-assembly image data acquired and the actual dimension detected; and evaluating the actual assembly model based on the ideal assembly model.

(Supplementary Note 11) The evaluation method according to (Supplementary Note 10), in which the formed object is a waveguide, and the plurality of the target object are components including a component having a waveguide tube and a component connected to the waveguide tube, or are components all having waveguide tubes.

(Supplementary Note 12) The evaluation method according to (Supplementary Note 10) or (Supplementary Note 11), in which a deviation in the actual assembly model from the ideal assembly model is detected as evaluation.

(Supplementary Note 13) The evaluation method according to (Supplementary Note 12), in which an evaluation result according to an amount of the deviation is output as the evaluation.

(Supplementary Note 14) The evaluation method according to (Supplementary Note 12) or (Supplementary Note 13), in which the deviation is positional deviation or impedance deviation.

(Supplementary Note 15) The evaluation method according to any one of (Supplementary Note 10) to (Supplementary Note 14), in which the ideal assembly model is generated based on the actual dimension detected and additional dimension data regarding a dimension of the target object supplied from outside.

(Supplementary Note 16) The evaluation method according to any one of (Supplementary Note 10) to (Supplementary Note 15), in which the actual assembly model is generated based on the post-assembly image data acquired, the actual dimension detected, and the additional dimension data regarding the dimension of the target object supplied from outside.

(Supplementary Note 17) The evaluation method according to any one of (Supplementary Note 10) to (Supplementary Note 16), in which data indicating the actual assembly model generated is converted into a format that can be taken in by an analysis means and output.

(Supplementary Note 18) The evaluation method according to any one of (Supplementary Note 10) to (Supplementary Note 17), in which in a case where the post-assembly image data is generated by imaging to include a part of the connection portion of the assembly, the actual assembly model is generated by complementing a connection portion undisplayed in an image indicated by the post-assembly image data based on the actual dimension detected.

(Supplementary Note 19) A program for causing a computer to function as: a pre-assembly image data acquisition means for acquiring pre-assembly image data generated by imaging by an imaging means to include a connection unit in a state where a target object is arranged such that an actual dimension of a shape of the connection unit of a plurality of the target object can be specified; an actual dimension detection means for detecting the actual dimension of the shape of the connection unit from the pre-assembly image data; an ideal assembly model generation means for generating an ideal assembly model representing a positional relationship between two of the connection unit having a connection relationship in a case where the target object is virtually assembled by connecting the target object at the connection unit such that a predetermined property of a formed object formed by connecting the target object at the connection unit is optimized, based on the actual dimension detected by the actual dimension detection means; a post-assembly image data acquisition means for acquiring post-assembly image data generated by imaging by an imaging means to include a connection portion of an assembly obtained by actually assembling the target object by connecting the target object at the connection unit; an actual assembly model generation means for generating an actual assembly model representing the positional relationship between the two of the connection unit having the connection relationship in the assembly based on the post-assembly image data and the actual dimension detected by the actual dimension detection means; and an evaluation means for evaluating the actual assembly model based on the ideal assembly model.

(Supplementary Note 20) The program according to (Supplementary Note 19), in which the formed object is a waveguide, and the plurality of the target object are components including a component having a waveguide tube and a component connected to the waveguide tube, or are components all having waveguide tubes.

(Supplementary Note 21) The program according to (Supplementary Note 19) or (Supplementary Note 20), in which the evaluation means detects a deviation in the actual assembly model from the ideal assembly model as evaluation.

(Supplementary Note 22) The program according to (Supplementary Note 21), in which the evaluation means outputs an evaluation result according to an amount of the deviation as the evaluation.

(Supplementary Note 23) The program according to (Supplementary Note 21) or (Supplementary Note 22), in which the deviation is positional deviation or impedance deviation.

(Supplementary Note 24) The program according to any one of (Supplementary Note 19) to (Supplementary Note 23), in which the ideal assembly model generation means generates the ideal assembly model based on the actual dimension detected by the actual dimension detection means and additional dimension data regarding a dimension of the target object supplied from outside.

(Supplementary Note 25) The program according to any one of (Supplementary Note 19) to (Supplementary Note 24), in which the actual assembly model generation means generates the actual assembly model based on the post-assembly image data, the actual dimension detected by the actual dimension detection means, and the additional dimension data regarding the dimension of the target object supplied from outside.

(Supplementary Note 26) The program according to any one of (Supplementary Note 19) to (Supplementary Note 25), in which the actual assembly model generation unit converts data indicating the actual assembly model to be generated into a format that can be taken in by an analysis means and outputs the data converted.

(Supplementary Note 27) The program according to any one of (Supplementary Note 19) to (Supplementary Note 26), in which the actual assembly model generation means generates the actual assembly model by complementing a connection portion undisplayed in an image indicated by the post-assembly image data based on the actual dimension detected by the actual dimension detection means in a case where the post-assembly image data is generated by imaging to include a part of the connection portion of the assembly.

(Supplementary Note 28) A waveguide evaluation apparatus including: a pre-assembly image data acquisition means (for example, the pre-assembly image data acquisition unit 11) for acquiring pre-assembly image data generated by imaging by an imaging means (for example, the imaging apparatus 2) to include a connection unit in a state where a plurality of components (for example, the components 20A, 20B, and 81, and the coaxial waveguide tube connection unit 90) each forming a waveguide by connecting the components are arranged such that an actual dimension of a shape of the connection unit of a plurality of the target object can be specified; an actual dimension detection means (for example, the actual dimension detection unit 12) for detecting the actual dimension of the shape of the connection unit from the pre-assembly image data; an ideal assembly model generation means (for example, ideal assembly model generation unit 13) for generating an ideal assembly model representing a positional relationship between two of the connection unit having a connection relationship in a case where the components are virtually assembled such that a predetermined property of the waveguide to be formed is optimized, based on the actual dimension detected by the actual dimension detection means; a post-assembly image data acquisition means (for example, the post-assembly image data acquisition unit 14) for acquiring post-assembly image data generated by imaging by an imaging means (for example, the imaging apparatus 2) to include a connection portion of an assembly obtained by actually assembling the components; an actual assembly model generation means (for example, the actual assembly model generation unit 15) for generating an actual assembly model representing the positional relationship between the two of the connection unit having the connection relationship in the assembly based on the post-assembly image data and the actual dimension detected by the actual dimension detection means; and an evaluation means (for example, the evaluation unit 16) for evaluating the actual assembly model based on the ideal assembly model.

(Supplementary Note 29) A waveguide evaluation method including: acquiring pre-assembly image data generated by imaging by an imaging means to include a connection unit in a state where the components are arranged such that an actual dimension of a shape of the connection unit of a plurality of the components forming a waveguide by connecting the components can be specified; detecting the actual dimension of the shape of the connection unit from the pre-assembly image data acquired; generating an ideal assembly model representing a positional relationship between two of the connection unit having a connection relationship in a case where the components are virtually assembled such that a predetermined property of the waveguide to be formed is optimized, based on the actual dimension detected; acquiring post-assembly image data generated by imaging by an imaging means to include a connection portion of an assembly obtained by actually assembling the components; generating an actual assembly model representing the positional relationship between the two of the connection unit having the connection relationship in the assembly based on the post-assembly image data acquired and the actual dimension detected; and evaluating the actual assembly model based on the ideal assembly model.

(Supplementary Note 30) A program for causing a computer to function as: a pre-assembly image data acquisition means for acquiring pre-assembly image data generated by imaging by an imaging means to include a connection unit in a state where the components are arranged such that an actual dimension of a shape of the connection unit of a plurality of the components forming a waveguide by connecting the components can be specified; an actual dimension detection means for detecting the actual dimension of the shape of the connection unit from the pre-assembly image data; an ideal assembly model generation means for generating an ideal assembly model representing a positional relationship between two of the connection unit having a connection relationship in a case where the components are virtually assembled such that a predetermined property of the waveguide to be formed is optimized, based on the actual dimension detected by the actual dimension detection means; a post-assembly image data acquisition means for acquiring post-assembly image data generated by imaging by an imaging means to include a connection portion of an assembly obtained by actually assembling the components; an actual assembly model generation means for generating an actual assembly model representing the positional relationship between the two of the connection unit having the connection relationship in the assembly based on the post-assembly image data and the actual dimension detected by the actual dimension detection means; and an evaluation means for evaluating the actual assembly model based on the ideal assembly model.

(Supplementary Note 31) An information processing apparatus including: an actual dimension detection means for detecting an actual dimension of a shape of a connection unit from pre-assembly image data generated by imaging by an imaging means to include the connection unit in a state where a target object is arranged such that the actual dimension of the shape of the connection unit of a plurality of the target object can be specified; and an ideal assembly model generation means for generating an ideal assembly model representing a positional relationship between two of the connection unit having a connection relationship in a case where the target object is virtually assembled by connecting the target object at the connection unit such that a predetermined property of a formed object formed by connecting the target object at the connection unit is optimized, based on the actual dimension detected by the actual dimension detection means.

(Supplementary Note 32) The information processing apparatus according to Supplementary Note 31, further including an actual assembly model generation means for generating an actual assembly model representing the positional relationship between the two of the connection unit having the connection relationship in an assembly based on post-assembly image data generated by imaging by an imaging means to include a connection portion of the assembly obtained by actually assembling the target object by connecting the target object at the connection unit, and the actual dimension detected by the actual dimension detection means.

(Supplementary Note 33) The information processing apparatus according to Supplementary Note 32, further including an evaluation means for evaluating the actual assembly model based on the ideal assembly model.

(Supplementary Note 34) The information processing apparatus according to Supplementary Note 33, in which the formed object is a waveguide, and the plurality of the target object are components including a component having a waveguide tube and a component connected to the waveguide tube, or are components all having waveguide tubes.

(Supplementary Note 35) The information processing apparatus according to Supplementary Note 33, in which the evaluation means detects a deviation in the actual assembly model from the ideal assembly model as evaluation.

(Supplementary Note 36) The information processing apparatus according to Supplementary Note 35, in which the evaluation means outputs an evaluation result according to an amount of the deviation as the evaluation.

(Supplementary Note 37) The information processing apparatus according to Supplementary Note 35 or 36, in which the deviation is positional deviation or impedance deviation.

(Supplementary Note 38) The information processing apparatus according to Supplementary Note 33, in which the ideal assembly model generation means generates the ideal assembly model based on the actual dimension detected by the actual dimension detection means and additional dimension data regarding a dimension of the target object supplied from outside.

(Supplementary Note 39) The information processing apparatus according to Supplementary Note 33, in which the actual assembly model generation unit converts data indicating the actual assembly model to be generated into a format that can be taken in by an analysis means and outputs the data converted.

(Supplementary Note 40) The information processing apparatus according to Supplementary Note 33, in which the actual assembly model generation means generates the actual assembly model by complementing a connection portion undisplayed in an image indicated by the post-assembly image data based on the actual dimension detected by the actual dimension detection means in a case where the post-assembly image data is generated by imaging to include a part of the connection portion of the assembly.

(Supplementary Note 41) An information processing method including: detecting an actual dimension of a shape of a connection unit from pre-assembly image data generated by imaging by an imaging means to include the connection unit in a state where a target object is arranged such that the actual dimension of the shape of the connection unit of a plurality of the target object can be specified; and generating an ideal assembly model representing a positional relationship between two of the connection unit having a connection relationship in a case where the target object is virtually assembled by connecting the target object at the connection unit such that a predetermined property of a formed object formed by connecting the target object at the connection unit is optimized, based on the actual dimension detected by the actual dimension detection means.

(Supplementary Note 42) The information processing method according to Supplementary Note 41, further including generating an actual assembly model representing the positional relationship between the two of the connection unit having the connection relationship in an assembly based on post-assembly image data generated by imaging by an imaging means to include a connection portion of the assembly obtained by actually assembling the target object by connecting the target object at the connection unit, and the actual dimension detected by the actual dimension detection means.

(Supplementary Note 43) The information processing method according to Supplementary Note 42, further including evaluating the actual assembly model based on the ideal assembly model.

(Supplementary Note 44) A program for causing a computer to function as: an actual dimension detection means for detecting an actual dimension of a shape of a connection unit from pre-assembly image data generated by imaging by an imaging means to include the connection unit in a state where a target object is arranged such that the actual dimension of the shape of the connection unit of a plurality of the target object can be specified; and an ideal assembly model generation means for generating an ideal assembly model representing a positional relationship between two of the connection unit having a connection relationship in a case where the target object is virtually assembled by connecting the target object at the connection unit such that a predetermined property of a formed object formed by connecting the target object at the connection unit is optimized, based on the actual dimension detected by the actual dimension detection means.

(Supplementary Note 45) The program according to Supplementary Note 44, the program causing the computer to function as an actual assembly model generation means for generating an actual assembly model representing the positional relationship between the two of the connection unit having the connection relationship in an assembly based on post-assembly image data generated by imaging by an imaging means to include a connection portion of the assembly obtained by actually assembling the target object by connecting the target object at the connection unit, and the actual dimension detected by the actual dimension detection means.

(Supplementary Note 46) The program according to Supplementary Note 45, the program causing the computer to function as an evaluation means for evaluating the actual assembly model based on the ideal assembly model.

1. An evaluation apparatus comprising:
a pre-assembly image data acquisition circuit configured to acquire pre-assembly image data generated by imaging by an imaging circuit to include connection units in a state where a plurality of target objects are arranged such that an actual dimension of shapes of the connection units of the plurality of the target objects can be specified;
an actual dimension detection circuit configured to detect the actual dimension of the shapes of the connection units from the pre-assembly image data;
an ideal assembly model generation circuit configured to generate an ideal assembly model representing a positional relationship between two of the connection units having a connection relationship in a case where the target objects are virtually assembled by connecting the target objects at the connection units such that a predetermined property of a formed object formed by connecting the target objects at the connection units are optimized, based on the actual dimension detected by the actual dimension detection circuit;
a post-assembly image data acquisition circuit configured to acquire post-assembly image data generated by imaging by an imaging circuit to include a connection portion of an assembly obtained by actually assembling the target objects by connecting the target objects at the connection units;
an actual assembly model generation circuit configured to generate an actual assembly model representing the positional relationship between the two of the connection units having the connection relationship in the assembly based on the post-assembly image data and the actual dimension detected by the actual dimension detection circuit; and
an evaluation circuit configured to evaluate the actual assembly model based on the ideal assembly model.

2. The evaluation apparatus according to claim 1, wherein:
the formed object is a waveguide, and
the plurality of the target objects are components including a component having a waveguide tube and a component connected to the waveguide tube, or are components all having waveguide tubes.

3. The evaluation apparatus according to claim 1, wherein
the evaluation circuit detects a deviation in the actual assembly model from the ideal assembly model as evaluation.

4. The evaluation apparatus according to claim 3, wherein
the evaluation circuit outputs an evaluation result according to an amount of the deviation as the evaluation.

5. The evaluation apparatus according to claim 3, wherein the deviation is positional deviation or impedance deviation.

6. The evaluation apparatus according to claim 1, wherein
the ideal assembly model generation circuit generates the ideal assembly model based on the actual dimension detected by the actual dimension detection circuit and additional dimension data regarding a dimension of the target objects supplied from outside.

7. The evaluation apparatus according to claim 1, wherein
the actual assembly model generation circuit generates the actual assembly model based on the post-assembly image data, the actual dimension detected by the actual dimension detection circuit, and the additional dimension data regarding the dimension of the target objects supplied from outside.

8. The evaluation apparatus according to claim 1, wherein
the actual assembly model generation circuit converts data indicating the actual assembly model to be generated into a format that can be taken in by an analysis circuit and outputs the data converted.

9. The evaluation apparatus according to claim 1, wherein
the actual assembly model generation circuit generates the actual assembly model by complementing a connection portion undisplayed in an image indicated by the post-assembly image data based on the actual dimension detected by the actual dimension detection circuit in a case where the post-assembly image data is generated by imaging to include a part of the connection portion of the assembly.

10. An evaluation method comprising:
acquiring pre-assembly image data generated by imaging by an imaging circuit to include connection units in a state where a plurality of target objects are arranged such that an actual dimension of shapes of the connection units of the plurality of the target objects can be specified;
detecting the actual dimension of the shapes of the connection units from the pre-assembly image data acquired;
generating an ideal assembly model representing a positional relationship between two of the connection units having a connection relationship in a case where the target objects are virtually assembled by connecting the target objects at the connection units such that a predetermined property of a formed object formed by connecting the target objects at the connection units is optimized, based on the actual dimension detected;
acquiring post-assembly image data generated by imaging by an imaging circuit to include a connection portion of an assembly obtained by actually assembling the target objects by connecting the target objects at the connection units;
generating an actual assembly model representing the positional relationship between the two of the connection units having the connection relationship in the assembly based on the post-assembly image data acquired and the actual dimension detected; and
evaluating the actual assembly model based on the ideal assembly model.

11. The evaluation method according to claim 10, wherein:
the formed object is a waveguide, and
the plurality of the target objects are components including a component having a waveguide tube and a component connected to the waveguide tube, or are components all having waveguide tubes.

12. The evaluation method according to claim 10, wherein
a deviation in the actual assembly model from the ideal assembly model is detected as evaluation.

13. The evaluation method according to claim 12, wherein
an evaluation result according to an amount of the deviation is output as the evaluation.

14. The evaluation method according to claim 12, wherein
the deviation is positional deviation or impedance deviation.

15. The evaluation method according to claim 10, wherein
the ideal assembly model is generated based on the actual dimension detected and additional dimension data regarding a dimension of the target objects supplied from outside.

16. The evaluation method according to claim 10, wherein
the actual assembly model is generated based on the post-assembly image data acquired, the actual dimension detected, and the additional dimension data regarding the dimension of the target objects supplied from outside.

17. The evaluation method according to claim 10, wherein
data indicating the actual assembly model generated is converted into a format that can be taken in by an analysis circuit and output.

18. The evaluation method according to claim 10, wherein
in a case where the post-assembly image data is generated by imaging to include a part of the connection portion of the assembly, the actual assembly model is generated by complementing a connection portion undisplayed in an image indicated by the post-assembly image data based on the actual dimension detected.

19. A tangible and non-transitory storage medium storing a program for causing a computer to function as:
a pre-assembly image data acquisition circuit configured to acquire pre-assembly image data generated by imaging by an imaging circuit to include connection units in a state where a plurality of target objects are arranged such that an actual dimension of a shapes of the connection units of the plurality of the target objects can be specified;
an actual dimension detection circuit configured to detect the actual dimension of the shapes of the connection units from the pre-assembly image data;
an ideal assembly model generation circuit configured to generate an ideal assembly model representing a positional relationship between two of the connection units having a connection relationship in a case where the target objects are virtually assembled by connecting the target objects at the connection units such that a predetermined property of a formed object formed by connecting the target objects at the connection units are optimized, based on the actual dimension detected by the actual dimension detection circuit;
a post-assembly image data acquisition circuit configured to acquire post-assembly image data generated by imaging by an imaging circuit to include a connection portion of an assembly obtained by actually assembling the target objects by connecting the target objects at the connection units;
an actual assembly model generation circuit configured to generate an actual assembly model representing the positional relationship between the two of the connection units having the connection relationship in the assembly based on the post-assembly image data and the actual dimension detected by the actual dimension detection circuit; and
an evaluation circuit configured to evaluate the actual assembly model based on the ideal assembly model.

20. The storage medium according to claim 19, wherein:
the formed object is a waveguide, and
the plurality of the target objects are components including a component having a waveguide tube and a component connected to the waveguide tube, or are components all having waveguide tubes.
